(19) United States
(12) Patent Application Publication
(10) Pub. No.: US 2024/0152372 A1
(43) Pub. Date: May 9, 2024

(54) VIRTUAL REPRESENTATIONS OF ENDPOINTS IN A COMPUTING ENVIRONMENT

(71) Applicant: Dell Products L.P., Round Rock, TX (US)

(72) Inventors: Ahmed Elshafey, New Cairo City (EG); Omar Abdulaal, New Cairo City (EG); Mahi Ismail, New Cairo City (EG)

(21) Appl. No.: 17/980,724

(22) Filed: Nov. 4, 2022

(51) Int. Cl. G06F 9/455

(52) U.S. Cl. CPC G06F 9/45558; G06F 2009/45595

(57) ABSTRACT

Techniques for construction and management of virtual representations (e.g., digital twins) of endpoints in a computing environment. For example, a method comprises generating one or more virtual representations of one or more endpoints in a computing environment. The method further comprises managing the one or more endpoints in the computing environment via the one or more virtual representations.

### FIELD

The field relates generally to computing environments, and more particularly to virtual representations (e.g., digital twins) in such computing environments.

### BACKGROUND

Endpoint management is one of the core information technology (IT) operations in any organization. “Endpoints” are devices that typically reside at “ends” (e.g., physical ends, geographic ends, logical ends, functional ends, communication link ends, etc.) of a given computing environment. For example, endpoints may be computing or processing devices that remotely connect to, or otherwise geographically reside remote from, a given centralized computing platform (e.g., a 5G core network, a data center, a public cloud platform, a private enterprise cloud platform, a hybrid (private/public) cloud platform, etc.). By way of example only, endpoints can comprise devices including, but not limited to, mobile devices (e.g., smart phones, laptops, etc.), personal computers (PC), and other computing devices (e.g., servers, gateways, appliances, Internet of Thing (IoT) devices, etc.) connected to one or more networks managed by an organization and/or some other entity.

However, IT administrators often have difficulty managing such endpoints, particularly when they need to test such endpoints, since they may not have accurate representations of the endpoints in the field (e.g., fleet of endpoints).

### SUMMARY

Embodiments provide techniques for construction and management of virtual representations of endpoints in a computing environment.

For example, according to one illustrative embodiment, a method comprises generating one or more virtual representations of one or more endpoints in a computing environment. The method further comprises managing the one or more endpoints in the computing environment via the one or more virtual representations.

Further illustrative embodiments are provided in the form of a non-transitory computer-readable storage medium having embodied therein executable program code that when executed by a processor causes the processor to perform the above steps. Additional illustrative embodiments comprise an apparatus with a processor and a memory configured to perform the above steps.

Advantageously, illustrative embodiments provide functionalities for on-demand high-fidelity replication and simulation of endpoints in an automated manner. More particularly, illustrative embodiments achieve the above advantages by constructing digital twins (i.e., virtual representations) of endpoints and managing attributes and operations associated with the endpoints using the digital twins.

These and other features and advantages of embodiments described herein will become more apparent from the accompanying drawings and the following detailed description.

### BRIEF DESCRIPTION OF THE DRAWINGS

FIG. 1 illustrates a digital twin environment according to an illustrative embodiment.

FIG. 2 illustrates a computing environment with endpoint digital twin creation and management according to an illustrative embodiment.

FIG. 3 illustrates a methodology for endpoint digital twin creation and management according to an illustrative embodiment.

FIGS. 4 and 5 illustrate examples of processing platforms that may be utilized to implement at least a portion of an information processing system with endpoint digital twin creation and management functionality according to one or more illustrative embodiments.

### DETAILED DESCRIPTION

Illustrative embodiments will now be described herein in detail with reference to the accompanying drawings. Although the drawings and accompanying descriptions illustrate some embodiments, it is to be appreciated that alternative embodiments are not to be construed as limited by the embodiments illustrated herein. Furthermore, as used herein, the term “includes” and its variants are to be read as open-ended terms that mean “includes, but is not limited to.” The term “based on” is to be read as “based at least in part on.” The term “an embodiment” and “the embodiment” are to be read as “at least one example embodiment.” The terms “first,” “second,” and the like may refer to different or the same objects. Other definitions, either explicit or implicit, may be included below.

It is realized herein that IT administrators often use unified endpoint management (UEM) to monitor endpoints and manually control them (e.g., make changes as needed). UEM is considered a class of software tools that provide a single management interface for endpoints. The existing UEM workflow requires IT administrators to test changes to one or more endpoints using base system images or testing units to see the effects of the changes before rolling them out to the one or more endpoints. However, this existing UEM approach does not provide accurate testing as it does not give IT administrators an accurate representation of the endpoints in the field (e.g., fleet of endpoints), which are often different from testing devices or base images. A base image may, for example, be an image of a device configuration before options have been installed and/or before customer-specific modifications are made. That is, while existing UEM tools provide relevant data points about endpoints, it is realized herein that it may not be advisable to rely on UEM data alone.

Further, it is realized herein that existing UEM workflows for testing changes to endpoints can impose many technical and other drawbacks to organizations. Testing or rolling out software changes across endpoints is slow to execute with rolling updates and can encounter unexpected operational issues. IT administrators need to test their changes first before rolling them out and this is usually done manually on select testing devices to act as samples for the endpoint fleets. This, however, does not reflect the current states of all endpoints and makes the testing process unreliable. Issues occur when rolling out changes across the entire fleet due to variance in the endpoints and can slow down the rollout process. Moreover, if problems are detected in later stages of the rollout, the ramifications of rolling back changes is significant and could be disruptive to the endpoints.

Still further, it is realized herein that predicting changes to entire network topologies due to endpoint changes often requires manual simulations and is time consuming. Simulating and verifying network changes in response to endpoint changes (e.g., software updates, adding or removing endpoints, etc.) is not possible with high fidelity and often relies on manually constructed simulations. Adding an endpoint can require allocating new Internet Protocol (IP) addresses, and adding new infrastructure such as switches or security appliances. The inverse goes for removing endpoints, which can produce redundancies. IT administrators usually use network simulation software to attempt to figure out these changes. This requires them to manually construct their network with connection endpoints and keep it constantly updated in terms of the software to obtain accurate results. Also, due to the limitations of the software, it is often not possible to represent all device types or configurations to reflect the network accurately.

Illustrative embodiments overcome the above and other technical drawbacks associated with existing UEM and other endpoint management approaches by providing functionalities for on-demand high-fidelity replication and simulation of all available endpoints in an automated way without the need for manual reconstruction. More particularly, illustrative embodiments achieve the above advantages by constructing digital twins of endpoints and managing attributes and operations associated with the endpoints using the digital twins.

A digital twin refers to a virtual representation or a virtual copy of a physical (e.g., actual or real) item such as, but not limited to, a system, a device, and/or processes associated therewith. By way of example, a digital twin can be used to analyze and understand performance of the physical item in order to achieve improved operations in the physical item, as well as in the computing environment in which the physical item is implemented. A digital twin can be embodied as one or more software programs that model, simulate, or otherwise represent attributes and operations of the physical item. Further, a digital twin may alternatively be illustratively referred to as a digital twin object or digital twin module, or simply as a digital object or digital module. A digital twin acts as abridge between the physical and digital worlds and can be created by collecting, inter alia, real-time data about the physical item. The data is then used to create a digital duplicate of the physical item, allowing the physical item and/or the environment in which the physical item operates in real-time to be understood, analyzed, manipulated, and/or improved.

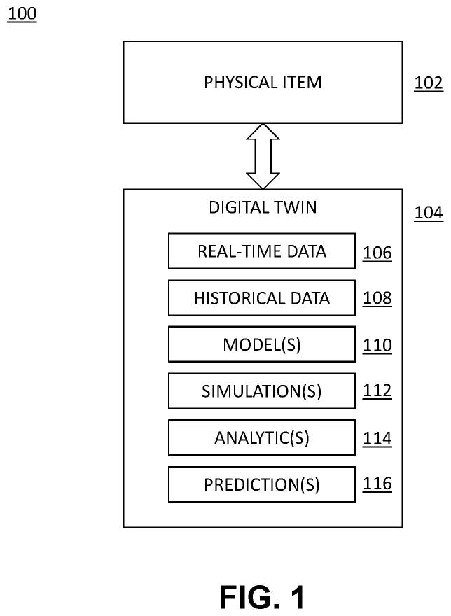

By way of example, FIG. 1 illustrates a digital twin environment 100 according to an illustrative embodiment. As shown, a physical item 102 is operatively coupled to a digital twin 104. While a single instance of digital twin 104 is depicted, it is to be understood that physical item 102 may be virtually represented by more than one instance of digital twin 104 (e.g., same or similar internal configurations) and/or by two or more different versions (e.g., different internal configurations) of digital twin 104. It is to be understood that the term physical item as illustratively used herein may include, but is not limited to, a hardware-based item, a software-based item, and a combination thereof. That is, for example, the digital twin may virtually represent a hardware component (e.g., a system, a device, etc.), a software component (e.g., program code executable on a hardware component that performs or causes performance of an operation, a process, etc.), and combinations thereof. As will be described in further detail herein, physical item 102 may comprise an endpoint.

Digital twin 104 is configured as shown with components comprising real-time data 106, historical data 108, one or more models 110, one or more simulations 112, one or more analytics 114, and one or more predictions 116. In general, digital twin 104 obtains real-time data 106, as well as other data, from physical item 102. Based on the real-time data 106, previously obtained historical data 108, and/or other data, digital twin 104 functions as a digital duplicate of physical item 102 and executes all or a subset of the one or more models 110, the one or more simulations 112, the one or more analytics 114, and the one or more predictions 116 to analyze and understand the attributes (e.g., parameters, settings, etc.) and operations (e.g., computations, functions, etc.) of physical item 102. Based on at least a portion of the results from execution of the one or more models 110, the one or more simulations 112, the one or more analytics 114, and the one or more predictions 116, digital twin 104 can then be used to manipulate the attributes and operations of physical item 102 to optimize or otherwise improve the operations of physical item 102.

Illustrative embodiments apply digital twin 104 to a computing environment for managing endpoints. More particularly, as will be described herein, illustrative embodiments provide a digital twin endpoint management solution that offers high-fidelity digital representation of endpoints across all endpoints or fleets in an organization and how they are connected over a network. By way of example, a digital twin of an endpoint in an illustrative system comprises a virtual replica describing hardware specifications, network specifications, hardware telemetry, and security information (e.g., vulnerabilities, etc.).

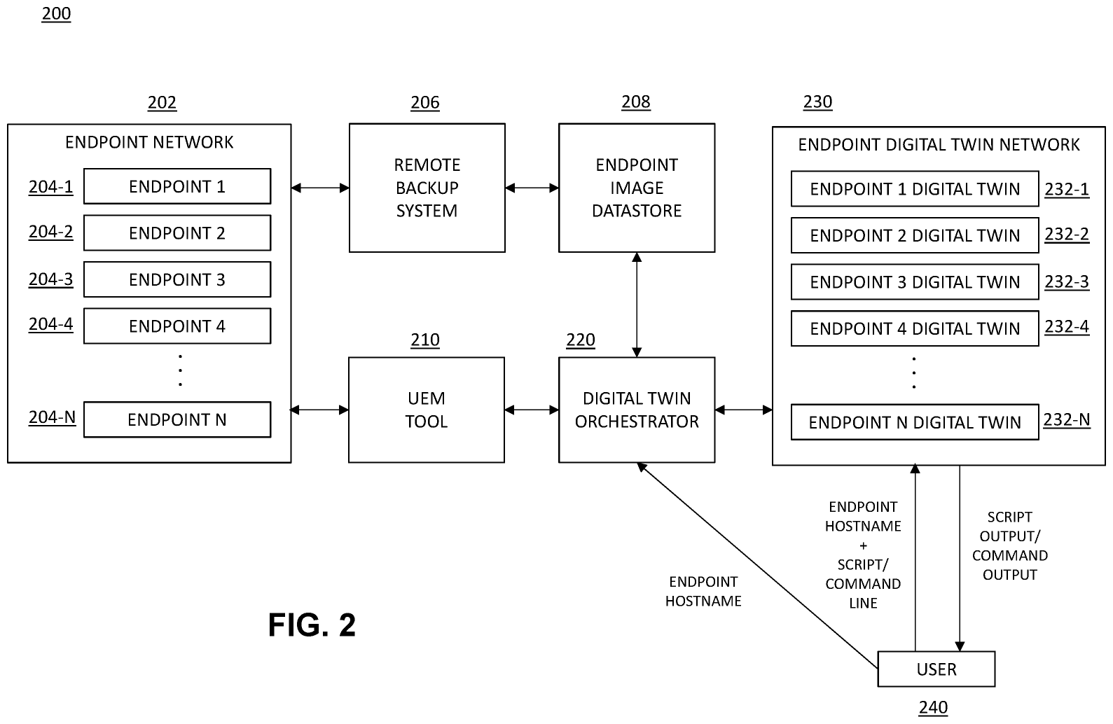

Referring now to FIG. 2, a computing environment 200 comprises an endpoint network 202, itself comprising a plurality of endpoints 204-1, 204-2, 204-3, 204-4, . . . , 204-N (referred to herein collectively as endpoints 204 and individually as endpoint 204). Endpoints 204 may comprise a wide variety of devices and/or infrastructure associated with endpoint network 202 including, but not limited to, smart phones, laptops, other mobile devices, personal computers (PC), servers (e.g., edge or otherwise), gateways, Internet of Thing (IoT) devices, switches, appliances, and other computing devices that are part of or otherwise associated with endpoint network 202. While endpoint network 202 is referred to in the singular, it is to be appreciated that, in illustrative alternative embodiments, endpoint network 202 may comprise multiple networks wherein a subset of devices of at least one network are interconnected with a subset of devices from at least another network.

Computing environment 200 further comprises a remote backup system 206 which is operatively coupled between endpoint network 202 and an endpoint image datastore 208. In one or more illustrative embodiments, remote backup system 206 is configured with existing endpoint backup software to generate backup images of endpoints 204 for use in simulating changes to endpoints 204 by allowing a user to interact with the backups and make changes manually. Such backup images are stored in endpoint image datastore 208.

Still further, computing environment 200 comprises a unified endpoint management (UEM) tool 210. In one or more illustrative embodiments, UEM tool 210 provides existing functionality via a single management interface for administrators to monitor and change endpoints 204. Endpoints 204 push information, either periodically or in real-time, to UEM tool 210 using agents respectively installed on endpoints 204 that capture telemetry data (e.g., Prometheus) and security data (e.g., Carbon Black, Rapid7).

Data from endpoint image datastore 208 and UEM tool 210 is provided as input to a digital twin orchestrator 220. Digital twin orchestrator 220, according to one or more illustrative embodiments, constructs a set of high-fidelity digital twins of endpoints 204, as will be further explained, using at least a portion of the data collected from endpoint image datastore 208 and UEM tool 210. More particularly digital twin orchestrator 220 constructs an endpoint digital twin network 230 comprising a plurality of endpoint digital twins 232-1, 232-2, 232-3, 232-4, . . . , 232-N (referred to herein collectively as endpoint digital twins 232 and individually as endpoint digital twin 232). In one or more illustrative embodiments, one or more endpoint digital twins 232 can be configured the same as or similar to digital twin 104 as shown in FIG. 1. In such a case, one or more models 110, one or more simulations 112, one or more analytics 114, and one or more predictions 116 are configured based on the particular endpoint 204 being virtually represented. Thus, some or all of real-time data 106 and/or some or all of historical data 108 can be data collected from endpoint image datastore 208 and/or UEM tool 210. As further shown in FIG. 2, a user 240 interacts with endpoint digital twins 232. User 240 can represent an individual, a computing system, or some combination thereof. In one example, user 240 comprises a system or IT administrator.

Note that while FIG. 2 illustrates a one-to-one correspondence between endpoints 204-1, 204-2, 204-3, 204-4, . . . , 204-N and endpoint digital twins 232-1, 232-2, 232-3, 232-4, . . . , 232-N, alternative embodiments may comprise alternative correspondences, e.g., a single endpoint digital twin 232 can represent more than one of endpoints 204, more than one of endpoint digital twins 232 can represent a single endpoint 204, etc.

In one or more illustrative embodiments, by way of example only, assume that a given endpoint digital twin 232 is needed/desired for on-demand simulations. That is, when user 240 wishes to simulate changes to a given endpoint 204, user 240 can request digital twin orchestrator 220 to create/construct (spin up or instantiate) a digital twin of the given endpoint 204 using one or more corresponding images from endpoint image datastore 208 augmented with real-time data from UEM tool 210. In some illustrative embodiments, digital twin orchestrator 220 instantiates one or more virtual machines/VMs (e.g., using vSphere) or one or more containers (e.g., using Kubernetes or KVM) to implement the given endpoint digital twin 232. Digital twin orchestrator 220 matches the specifications of the given endpoint 204 and loads the one or more corresponding images to create a high-fidelity representation (endpoint digital twin 232) of the given endpoint 204. User 240 can then use the constructed endpoint digital twin 232 to test and/or simulate changes to the given endpoint 204.

With reference back to digital twin 104 of FIG. 1, one or more models 110, one or more simulations 112, one or more analytics 114, and/or one or more predictions 116 may be used to mirror the configuration and operations of the given endpoint 204 based on the one or more corresponding images from endpoint image datastore 208 augmented with real-time data from UEM tool 210.

Accordingly, in an exemplary operation with respect to an illustrative embodiment, UEM tool 210 periodically polls data from endpoints 204 through respective application programming interfaces (APIs) in real-time. Digital twin orchestrator 220 then creates endpoint digital twins 232 of endpoints 204. Given that UEM tool 210 collects only information and metadata, remote backup system 206 is used to generate backup images of data and system files of endpoints 204 so they can be later spun up to virtualize endpoints 204 and simulate changes. Remote backup system 206 takes daily backups of endpoints 204 and stores them in an accessible image store (endpoint image datastore 208) to have ready-to-spin replicas for simulations.

As mentioned above, digital twin orchestrator 220 creates endpoint digital twins 232 using hardware specifications of endpoints 204. By way of example only, existing products such as Microsoft Intune or VMware Carbon Black Kenna can be adapted to provide the hardware specifications, e.g., specifications on memory, platform, CPU, GPU, etc. of each endpoint 204. Digital twin orchestrator 220 also uses operating system files, software, and data on endpoints 204 to create endpoint digital twins 232. By way of example only, existing products such as Druva InSync can be adapted to provide daily backup of the data on each endpoint 204.

In one illustrative embodiment, digital twin orchestrator 220 can comprise an Ansible playbook configured with the following illustrative workflow:
(i) Scheduled periodically;
(ii) Call UEM (UEM tool 210) APIs to retrieve endpoint metadata;
(iii) Call remote backup (remote backup system 206/endpoint image datastore 208) APIs to register latest images with vSphere content library; and
(iv) Call vSphere API to deploy or update instances with latest images.

This illustrative workflow would create an endpoint digital twin 232 on a new VM in vCenter (exemplary virtualization platform that is part of endpoint digital twin network 230) with the target endpoint specifications collected from UEM tool 210 and the backup images generated from remote backup system 206 mounted to their respective volumes as they exist on the corresponding endpoint 204.

As further shown in FIG. 2, computing environment 200 provides functionalities comprising:
(i) Create digital twin function—when an administrator (user 240) wishes to create a digital twin of one of their endpoints, they interact with digital twin orchestrator 220 by providing, as input, the endpoint hostname of the endpoint 204 for which they wish to have an endpoint digital twin 232 created. Digital twin orchestrator 220 starts a new job to create a VM of the selected host on a virtualization platform using the specifications collected by the endpoint agent by UEM tool 210 and the disk images from the content library on endpoint image datastore 208.
(ii) Destroy digital twin function—when the administrator (user 240) no longer needs the endpoint digital twin 232, they would call digital twin orchestrator 220 with the endpoint hostname, as input, to delete the endpoint digital twin 232.
(iii) Run script function—when the administrator (user 240) wishes to execute a script to test changes to the endpoint 204, they would interact with endpoint digital twin network 230 providing the script and hostname as input. Endpoint digital twin network 230 causes execution of the script on the corresponding endpoint digital twin 232 and provides command line interface (CLI) script output to the administrator.
(iv) Run command function—when the administrator (user 240) wishes to run a single command on an endpoint digital twin 232, they would call this function with the hostname and the command line to run. Endpoint digital twin network 230 causes execution of the command line on the corresponding endpoint digital twin 232 and provides command line output to the administrator.

In one or more illustrative embodiments, hostnames in the virtualized digital twin fleet of endpoint digital twin network 230 would mirror the same hostnames from the endpoint fleet of endpoint network 202 so the user 240 can interact with the endpoint digital twins 232 the same way they would interact with their actual endpoints 204. The user 240 also has access to all the additional functionality offered by the virtualization platform (vCenter) as part of the implementation of endpoint digital twin network 230 such as, by way of example only, connecting with Secure Shell (SSH) protocol SSH or Virtual Network Connecting (VNC) protocol, mount and unmount volumes, etc.

Advantageously, illustrative embodiments enable on-demand network and endpoint simulation by providing functionalities to virtualize and simulate changes (e.g., software updates) to every endpoint in the network as they are currently configured. This can be done on a single endpoint level by spinning up virtual machines and making changes manually or preloading scripts. It can also be done for an entire fleet of machines using containers and scripts to execute changes. Illustrative embodiments provide IT administrators with the facility to test out any changes they wish to make to all endpoints, reflected accurately with recent images of each endpoint.

Illustrative embodiments also enable active simulation of network changes by predicting network changes in response to endpoint changes without the need to manually build digital reconstructions of the network. Further, active simulation of network changes is achieved by predicting and simulating network topology and global changes in response to endpoint changes and vice versa. Administrators can test out what would happen (e.g., what-if scenario testing) when removing or adding infrastructure devices or making configuration changes to the network. They can also see any changes to the network that would be required when adding or removing endpoints or changing endpoint configurations.

In one exemplary use case, assume an IT administrator wishes to add new endpoint devices for a group of new employees. The IT administrator would need to know what changes to the network, if any, would be needed to make room for the new devices. This can include allocating more Internet Protocol (IP) addresses, adding new switches, changing locations of some devices such as access points, or other changes to enable service for the new devices. Advantageously, the IT administrator can utilize technical solutions described herein to test out these additions in the digital twin model to find all the relevant changes they need to make to the network before adding these new devices.

In another exemplary use case, assume an IT administrator wishes to add new software or remove existing software from all endpoints. The IT administrator would need to know the impact of that change before making it as it can break devices or halt operations. Advantageously, the IT administrator can utilize technical solutions described herein to test out the changes on all devices with current image replicas of each device in their endpoint fleet to see how the changes would affect the endpoints and if any one endpoint or category of endpoints would break due to the changes.

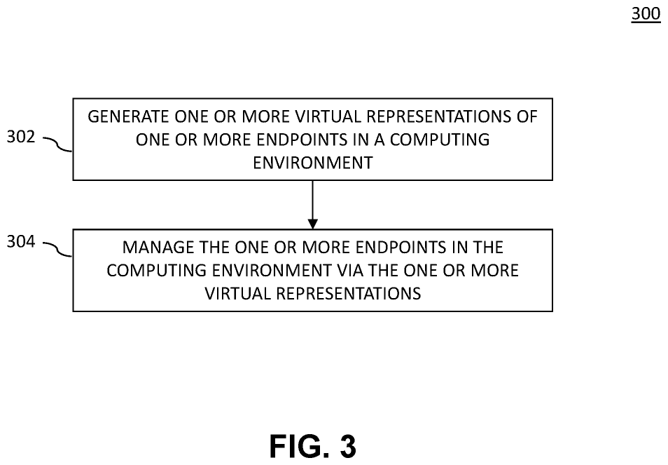

FIG. 3 illustrates a methodology 300 according to an illustrative embodiment. It is to be understood that, in illustrative embodiments, methodology 300 is performed by computing environment 200 of FIG. 2.

As shown, step 302 generates one or more virtual representations of one or more endpoints in a computing environment, and step 304 manages the one or more endpoints in the computing environment via the one or more virtual representations.

For example, as mentioned above, the one or more endpoints may comprise one or more devices operatively coupled to at least one centralized computing platform (e.g., a 5G core network, a data center, a public cloud platform, a private enterprise cloud platform, a hybrid cloud platform, etc.).

Further, the generating step (step 302) may further comprise, for a given endpoint of the one or more endpoints: obtaining device configuration-related metadata for the given endpoint; obtaining data configuration-related metadata for the given endpoint; and creating a virtualized replica of the given endpoint based on at least a portion of the device configuration-related metadata and the data configuration-related metadata.

By way of example only, device configuration-related metadata for the given endpoint may comprise one or more of hardware specifications, network specifications, hardware telemetry, and security information associated with a current device configuration of the given endpoint. At least a portion of the device configuration-related metadata may be obtained from a unified endpoint management tool operatively coupled to the one or more endpoints.

By way of further example only, data configuration-related metadata for the given endpoint may comprise one or more images generated of one or more of data, software, and system files associated with the given endpoint. Data configuration-related metadata for the given endpoint may be obtained from a remote backup system operatively coupled to the one or more endpoints.

It is to be understood that creating a virtualized replica of the given endpoint based on at least a portion of the device configuration-related metadata and the data configuration-related metadata may further comprise instantiating one or more virtual processing elements (e.g., VMs, containers, etc.) in which to execute the virtualized replica of the given endpoint by mirroring, in the virtualized replica, at least a portion of the device configuration-related metadata and the data configuration-related metadata of the given endpoint. Initially, generating one or more virtual representations of one or more endpoints in a computing environment may further comprise receiving an identifier of a given one of the one or more endpoints for which a given virtual representation is to be generated.

Further, the managing step (step 304) may further comprise, for a given endpoint of the one or more endpoints: applying a change to a corresponding one of the one or more virtual representations to simulate application of the change to the given endpoint; and presenting results of the applying of the change. Applying a change to the virtual representation of the given endpoint to simulate application of the change to the given endpoint may further comprise: receiving an identifier of the given endpoint; identifying the corresponding one of the one or more virtual representations based on the received identifier; receiving the change to be applied to the corresponding one of the one or more virtual representations; and executing the change to the corresponding one of the one or more virtual representations. The change may be defined via a script or a command line.

It is to be further understood that a given one of the one or more virtual representations may comprise one or more digital twin models of a corresponding one of the one or more endpoints in the computing environment.

The particular processing operations and other system functionality described in conjunction with the diagrams described herein are presented by way of illustrative example only, and should not be construed as limiting the scope of the disclosure in any way. Alternative embodiments can use other types of processing operations and messaging protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

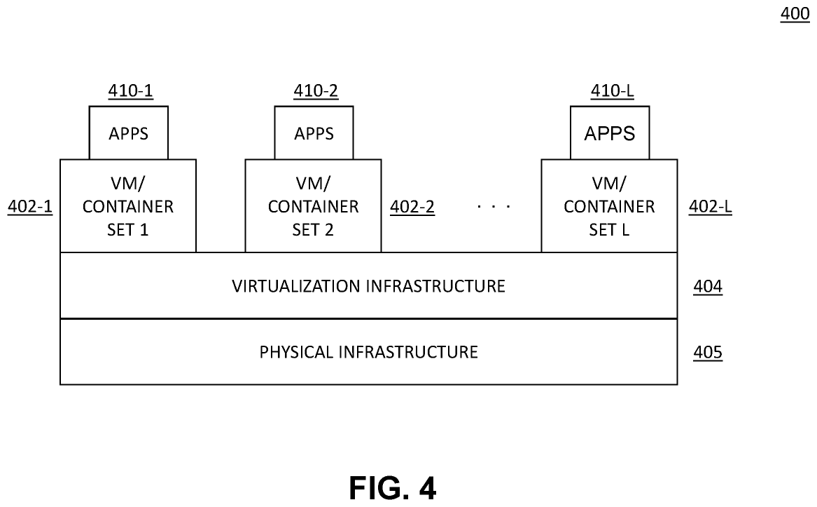

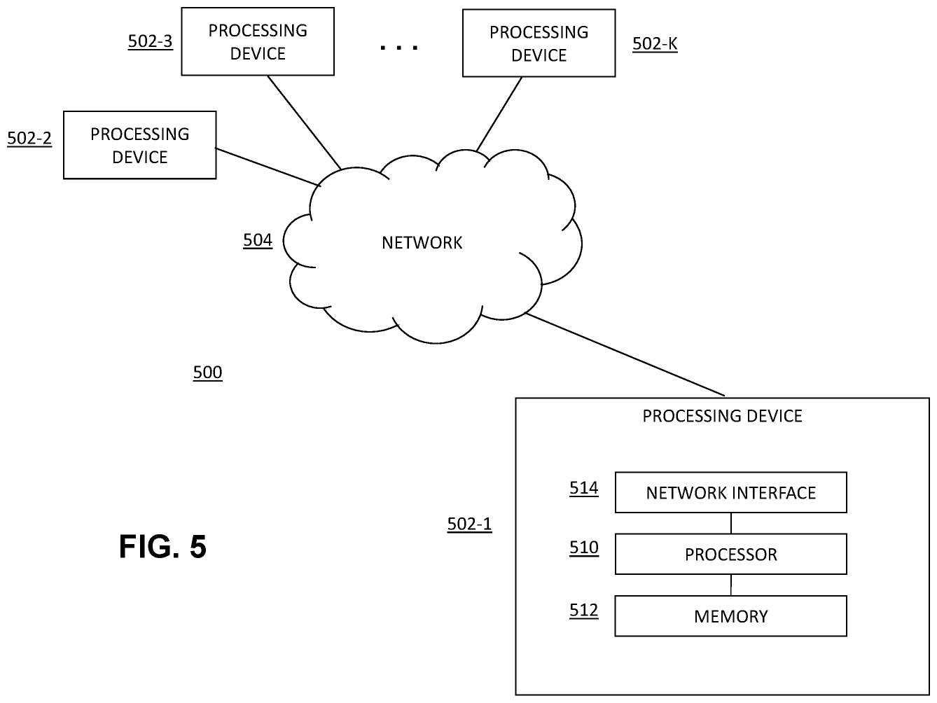

Illustrative embodiments of processing platforms utilized to implement functionality for ring architecture-based workload management in a microservice computing environment will now be described in greater detail with reference to FIGS. 4 and 5. Although described in the context of systems/module/processes of FIGS. 1-3, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that may be utilized to implement at least a portion of computing environment 200. The cloud infrastructure 400 comprises multiple VM/container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure.

The cloud infrastructure 400 further comprises sets of applications 410-1, 410-2, . . . 410-L running on respective ones of the VM/container sets 402-1, 402-2, . . . 402-L under the control of the virtualization infrastructure 404. The VM/container sets 402 may comprise respective sets of one or more VMs and/or one or more containers.

In some implementations of the FIG. 4 embodiment, the VM/container sets 402 comprise respective containers implemented using virtualization infrastructure 404 that provides operating system level virtualization functionality, such as support for Kubernetes-managed containers.

As is apparent from the above, one or more of the processing modules or other components of computing environment 200 may each run on a computer, server, storage device or other processing platform element. A given such element may be viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of computing environment 200 and includes a plurality of processing devices, denoted 502-1, 502-2, 502-3, . . . 502-K, which communicate with one another over a network 504.

The network 504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 502-1 in the processing platform 500 comprises a processor 510 coupled to a memory 512.

The processor 510 may comprise a microprocessor, a microcontroller, an application-specific integrated circuit (ASIC), a field-programmable gate array (FPGA) or other type of processing circuitry, as well as portions or combinations of such circuitry elements.

The memory 512 may comprise random access memory (RAM), read-only memory (ROM), flash memory or other types of memory, in any combination. The memory 512 and other memories disclosed herein should be viewed as illustrative examples of what are more generally referred to as “processor-readable storage media” storing executable program code of one or more software programs.

Articles of manufacture or computer program products comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and systems/modules/processes of FIGS. 1-3 may include additional or alternative processing platforms, as well as numerous distinct processing platforms in any combination, with each such platform comprising one or more computers, servers, storage devices or other processing devices.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality as disclosed herein are illustratively implemented in the form of software running on one or more processing devices.

In some embodiments, storage systems may comprise at least one storage array implemented as a Unity, PowerMax, PowerFlex (previously ScaleIO) or PowerStore storage array, commercially available from Dell Technologies. As another example, storage arrays may comprise respective clustered storage systems, each including a plurality of storage nodes interconnected by one or more networks. An example of a clustered storage system of this type is an XtremIO™ storage array from Dell Technologies, illustratively implemented in the form of a scale-out all-flash content addressable storage array.

It should again be emphasized that the above-described embodiments are presented for purposes of illustration only. Many variations and other alternative embodiments may be used. For example, the disclosed techniques are applicable to a wide variety of other types of information processing systems, host devices, storage systems, container monitoring tools, container management or orchestration systems, container metrics, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
generating one or more virtual representations of one or more endpoints in a computing environment; and
managing the one or more endpoints in the computing environment via the one or more virtual representations;
wherein the generating and managing steps are performed by at least one processor and at least one memory storing executable computer program instructions.

2. The method of claim 1, wherein the one or more endpoints comprises one or more devices operatively coupled to at least one centralized computing platform.

3. The method of claim 1, wherein the generating step further comprises, for a given endpoint of the one or more endpoints:
obtaining device configuration-related metadata for the given endpoint;
obtaining data configuration-related metadata for the given endpoint; and
creating a virtualized replica of the given endpoint based on at least a portion of the device configuration-related metadata and the data configuration-related metadata.

4. The method of claim 3, wherein device configuration-related metadata for the given endpoint comprises one or more of hardware specifications, network specifications, hardware telemetry, and security information associated with a current device configuration of the given endpoint.

5. The method of claim 4, wherein at least a portion of the device configuration-related metadata is obtained from a unified endpoint management tool operatively coupled to the one or more endpoints.

6. The method of claim 3, wherein data configuration-related metadata for the given endpoint comprises one or more images generated of one or more of data, software, and system files associated with the given endpoint.

7. The method of claim 6, wherein data configuration-related metadata for the given endpoint is obtained from a remote backup system operatively coupled to the one or more endpoints.

8. The method of claim 3, wherein creating a virtualized replica of the given endpoint based on at least a portion of the device configuration-related metadata and the data configuration-related metadata further comprises:
instantiating one or more virtual processing elements in which to execute the virtualized replica of the given endpoint by mirroring, in the virtualized replica, at least a portion of the device configuration-related metadata and the data configuration-related metadata of the given endpoint.

9. The method of claim 8, wherein the one or more virtual processing elements comprise one or more virtual machines and/or one or more containers.

10. The method of claim 1, wherein generating one or more virtual representations of one or more endpoints in a computing environment further comprises:
receiving an identifier of a given one of the one or more endpoints for which a given virtual representation is to be generated.

11. The method of claim 1, wherein the managing step further comprises, for a given endpoint of the one or more endpoints:
applying a change to a corresponding one of the one or more virtual representations to simulate application of the change to the given endpoint; and
presenting results of the applying of the change.

12. The method of claim 11, wherein applying a change to the virtual representation of the given endpoint to simulate application of the change to the given endpoint further comprises:
receiving an identifier of the given endpoint; and
identifying the corresponding one of the one or more virtual representations based on the received identifier.

13. The method of claim 12, wherein applying a change to the virtual representation of the given endpoint to simulate application of the change to the given endpoint further comprises:
receiving the change to be applied to the corresponding one of the one or more virtual representations; and
executing the change to the corresponding one of the one or more virtual representations.

14. The method of claim 13, wherein the change is defined via a script or a command line.

15. The method of claim 1, wherein a given one of the one or more virtual representations comprises one or more digital twin models of a corresponding one of the one or more endpoints in the computing environment.

16. An apparatus, comprising:
at least one processor and at least one memory storing computer program instructions wherein, when the at least one processor executes the computer program instructions, the apparatus is configured to:
generate one or more virtual representations of one or more endpoints in a computing environment; and
manage the one or more endpoints in the computing environment via the one or more virtual representations.

17. The apparatus of claim 16, wherein the generating further comprises, for a given endpoint of the one or more endpoints:
obtaining device configuration-related metadata for the given endpoint;
obtaining data configuration-related metadata for the given endpoint; and
creating a virtualized replica of the given endpoint based on at least a portion of the device configuration-related metadata and the data configuration-related metadata.

18. The apparatus of claim 16, wherein a given one of the one or more virtual representations comprises one or more digital twin models of a corresponding one of the one or more endpoints in the computing environment.

19. A computer program product stored on a non-transitory computer-readable medium and comprising machine executable instructions, the machine executable instructions, when executed, causing a processing device to perform steps of:
generating one or more virtual representations of one or more endpoints in a computing environment; and
managing the one or more endpoints in the computing environment via the one or more virtual representations.

20. The computer program product of claim 19, wherein the generating further comprises, for a given endpoint of the one or more endpoints:
obtaining device configuration-related metadata for the given endpoint;
obtaining data configuration-related metadata for the given endpoint; and
creating a virtualized replica of the given endpoint based on at least a portion of the device configuration-related metadata and the data configuration-related metadata.
